(19) United States
(12) Patent Application Publication
(10) Pub. No.: US 2018/0034111 A1
(43) Pub. Date: Feb. 1, 2018

(54) BATTERY CELL FOR A BATTERY OF A MOTOR VEHICLE, BATTERY AND MOTOR VEHICLE

(71) Applicant: AUDI AG, Ingolstadt (DE)

(72) Inventors: Michael HINTERBERGER, Großmehring (DE); Berthold HELLENTHAL, Schwanstetten (DE)

(73) Assignee: Audi AG, Ingolstadt (DE)

(21) Appl. No.: 15/551,174

(22) PCT Filed: Feb. 12, 2016
(86) PCT No.: PCT/EP2016/053082

§ 371 Date: Aug. 15, 2017

(30) Foreign Application Priority Data
Feb. 18, 2015 (DE) 10 2015 002 080.3

(51) Int. Cl. H01M 10/42; H01M 10/48; H01M 2/34

(52) U.S. Cl. CPC H01M 10/4257; H01M 2/34; H01M 10/48; H01M 2010/4271; H01M 2010/4278; H01M 2220/20; B60L 11/1851

(57) ABSTRACT

A battery cell for a battery of a motor vehicle having a galvanic element with a first electrode and a second electrode, a battery cell housing with a first connection terminal and a second connection terminal, at least one sensor device for detecting a physical and/or chemical property of the battery cell, and a control device. The galvanic element is disposed in the battery cell housing, wherein the battery cell has a switching means, by means of which the first connection terminal and the second connection terminal, can be electrically connected, and the control device closes the switching means to bridge over or bypass the battery cell as a function of the physical and/or chemical property.

The invention relates to a battery cell for a battery of a motor vehicle having a galvanic element with a first electrode and a second electrode, a battery cell housing with a first connection terminal and a second connection terminal, at least one sensor device for detecting a physical and/or chemical property of the battery cell, and a control device, wherein the galvanic element is arranged in the battery cell housing. The invention relates also to a battery as well as to a motor vehicle.

In known battery cells, usually a galvanic element is disposed in a battery cell housing each time. In order to provide a specific voltage or a specific current, a plurality of battery cells can be connected together to form a battery. These batteries are used today, in particular, as traction batteries in motor vehicles, for example, in electric or hybrid vehicles, for driving motor vehicles. These batteries must fulfill specific requirements, however, when used as batteries in motor vehicles. Since traction batteries can provide several hundred volts, special safety measures must be met in order to avoid, for example, an endangering of persons. In addition, a high availability of the battery must be ensured. This availability is particularly dependent on the extent of damage or of aging of the battery. Since battery cells have fluctuations in their capacitance as well as in their internal resistance, which are caused during their manufacture, they are usually charged and discharged at different rates. The battery can be damaged thereby, if individual cells are completely discharged or over-charged, for example. A damaging or a failure of one battery cell can therefore have as a consequence a failure of the entire battery, in particular when the battery cells are connected in series.

In order to monitor a battery or individual battery cells, measures are known from the prior art. Thus, DE 10 2010 011 740 A1 shows a battery, in which the state of individual battery cells is detected by sensors and is sent wirelessly to an over-riding central unit. A battery monitoring system is described in WO 2012/034045 A1, in which a measuring instrument is installed in or on a battery cell. Also, WO 2004/047215 A1 discloses a battery management system, in which physical properties of the battery are monitored in order to prolong the service life thereof.

The object of the present invention is to configure battery cells in a particularly safe manner.

This object is achieved according to the invention by a battery cell, a battery, as well as a motor vehicle with the features according to the independent patent claims. Advantageous embodiments of the invention are the subject of dependent patent claims, the description, and the figure.

The battery cell according to the invention for a battery of a motor vehicle comprises a galvanic element with a first electrode and a second electrode, a battery cell housing with a first connection terminal and a second connection terminal, at least one sensor device for detecting a physical and/or chemical property of the battery cell, and a control device, wherein the galvanic element is disposed in the battery cell housing. Moreover, the battery cell has a switching means, by means of which the first connection terminal and the second connection terminal can be electrically connected. In addition, the control device is designed for the purpose of closing the switching means as a function of the physical and/or chemical property detected by the sensor device, in order to bridge over or bypass the battery cell.

The galvanic element is particularly configured as a secondary cell, which can be discharged to supply an electrical component and can be charged again after it is discharged. The galvanic element is disposed in the battery cell housing, whereby the first electrode of the galvanic element is coupled electrically to the first connection terminal, and the second electrode of the galvanic element is electrically coupled to the second connection terminal. Therefore, the electrical energy provided by the galvanic element can be tapped at the connection terminals, for example, for supplying an electrical component. It is also possible to introduce energy for charging to the galvanic element by way of the connection terminals. In addition, the battery cell can be wired by way of the connection terminals to other similar battery cells to form a battery.

The at least one sensor device, which can be disposed inside or outside the battery cell housing, serves for detecting physical and/or chemical properties of the battery cell. The at least one sensor device or the sensor can be configured as a so-called microelectromechanical system (MEMS). The sensor can be designed, for example, as at least one of the following sensors: vibration sensor; acceleration sensor; gyroscope; temperature sensor; force sensor; pressure sensor; bending sensor; expansion or strain sensor; path sensor, inclination sensor; distance sensor; proximity sensor; optical sensor, for example opto sensor, light sensor; UV sensor; color sensor; IR sensor, in particular an NDIR (non-dispersive infrared) sensor; spectral sensor; sensor for measuring fill level, for example for measurement of electrolyte fill level; sensor for conductivity measurement, for example for measurement of the conductivity of the electrolyte; sensor for particle detection for the detection of free, moving molecules, atoms, or elementary particles; sensor for current measurement; magnetic field sensor; Hall sensor; sensor for voltage measurement; gas sensor, for example for the gas composition inside the battery cell; electrochemical sensor; for example for the chemical composition of the electrolyte or gas; pH sensor; ultrasound sensor; inductive sensor for highly precise distance measurement; piezoelectric sensor; or photoelectric sensor.

The physical and/or chemical properties of the battery cell, thus the sensor data detected by the at least one sensor device, are transmitted to the control device as signals by way of a signal path. The transmission of signals by way of the signal path can be produced wirelessly, for example via infrared, Bluetooth, WLAN; RFID (radio frequency identification) or WiFi; or can be produced by wired connection. For transmission by wired connection, the at least one sensor device and the control device can be coupled via electrical lines, for example flexible printed circuit boards; optical lines, for example glass fibers; or via bus systems, for example LIN, CAN, I²C, SPI, UART.

In this case, it can be provided that all sensor devices of the battery cell and the control device are configured as network nodes for a network. Here, the network can be designed, for example, as a full mesh net as a possible network topology. In a full mesh net, each of the sensor devices can communicate with the control device directly or via at least one other sensor device. In other words, this means that each of the sensor devices is designed for the purpose of receiving the signal of another sensor device and conveying it further. The signal transmission between the control device and the sensor device and thus a monitoring of the battery cell is configured to be particularly safe due to this redundant signal path.

The control device can comprise at least one microcontroller, for example, a digital signal processor (DSP) or an FPGA (field programmable gate array). In the case of an FGPA, there results the advantage that all functions of the control device can be programmed, even subsequently, for example, they can be added or deleted. The control device may also have more than one microcontroller, and these may fulfill different functions or tasks. This microcontroller can be designed, for example, as a one-chip system or an SoC (system-on-a-chip). It can also be provided that the control device is designed as a decentralized distributed system, in which the microcontrollers are disposed partly inside the battery cell housing and partly outside the battery cell housing, and, for example, communicate with one another by way of a wireless transmission device.

Based on the signals of the at least one sensor device, the control device can compute or determine battery-specific characteristic values. Such a battery-specific characteristic value can be, for example, a state of charge, a so-called state of health, a service life expectancy or remaining service life, or a degree of damage of the battery cell. For this purpose, for example, models for the battery cell are filed in the control device, and the control device determines the battery-specific characteristic data based on these models.

The switching means can be designed, for example, as a relay or as a semiconductor switching element, wherein the switching means is connected in each case to the connection terminals of the battery cell housing, for example, via a bus bar. If the switching means is opened, current cannot flow over the bus bars and the switching means between the connection terminals. Thus, in the opened state, the battery cell can be used as intended for providing electrical energy and/or for charging. If the switching means is closed, a current can flow over the bus bars and the switching means between the connection terminals. In this case, the galvanic element is bridged over or bypassed.

If, for example, the control device has determined that the battery cell has been damaged, the control device is designed for the purpose of actuating the closing of the switching means. This option of bypassing or bridging over is particularly advantageous in the case of a serial connection of battery cells. That is, for example, if one of the serially connected battery cells is defective, thus is damaged, then this battery cell can be bypassed by means of the switching means. According to the prior art, the current flow in the serial connection through a defective battery cell would be interrupted. By means of the presently described battery cell, the defective battery cell can be bypassed in a simple way and a current flow can be conducted via the switching means of the defective battery cell to the adjacent battery cells. Expressed in another way, the current can be maintained inside the serial circuit, and thus functionality of the entire battery can be maintained. In this way, the battery, which is disposed, for example, in the motor vehicle for driving the motor vehicle, can additionally provide electrical energy. Therefore, a driver of the motor vehicle advantageously has the option of driving the motor vehicle to a service station.

The switching means is more preferably disposed in the battery cell housing and thermally coupled to the battery cell housing. Therefore, the switching means is arranged in the battery cell housing in a particularly space-saving manner, and heat that arises during operation of the switching means can be discharged at the battery cell housing and can be further delivered to the surroundings of the battery cell.

An advantageous embodiment of the invention provides that at least one of the electrodes is connected to one of the connection terminals by way of an electronic switching element, wherein the electronic switching element is designed for the purpose of limiting a current flow between the electrode and the particular connection terminal, and the control device is designed for the purpose of actuating the electronic switching element for limiting the current flow, as a function of the physical and/or chemical property detected by the at least one sensor device. The electronic switching element is particularly configured as a semiconductor switch, in which a current flow via the electronic switching element is controllable by means of a control voltage at the electronic switching element. The switching element, which can be configured, for example, as a power MOSFET (metal-oxide semiconductor field-effect transistor) or as an IGBT (insulated gate bipolar transistor), can be operated as a function of the control voltage in different regions. If the electronic switching element is operated in a blocking region, then if the control voltage goes below a predetermined threshold value, the electronic switching element stops or blocks a current flow between the electrode and the particular connection terminal. If the electronic switching element is operated in a linear region or a triode region, then the current flow can be increased linearly by increasing the control voltage. If the electronic switching element is operated in a saturation region, then a constant, maximum current can flow between the connection terminal and the electrode starting from a specific control voltage. The control device is now designed for the purpose of correspondingly regulating the control voltage, so that the suitable region is provided based on the detected physical and/or chemical property.

If the at least one sensor device has a force sensor, for example, which is designed for the purpose of detecting a deformation of the galvanic element, then the control device can determine the degree of damage of the battery cell based on the detected deformation. Dependent on this degree of damage, the control device can actuate the electronic switching element for limiting a current flow. In other words, this means that the current withdrawn from the battery cell or the current conveyed to the battery cell is limited, i.e., is reduced to a value smaller than the maximum current value. For this purpose, the electronic switching element is operated in the linear region. Thus, an operating strategy can be adapted in an advantageous way to a state, for example, to an age or to a degree of damage of the battery cell, and in this way, the remaining service life of the battery cell can be extended.

Particularly preferred, the at least one sensor device is designed for the purpose of detecting an insulation resistance between the galvanic element and the battery cell housing. In addition, the control device is designed for the purpose of closing the switching means for bridging over the connection terminals, and to actuate the electronic switching element for limiting the current, if the insulation resistance goes below a predetermined threshold value for the insulation resistance.

The battery cell housing can be configured as a two-part aluminum housing, wherein, after integration of the galvanic element or of the battery cell coil, the two parts can be welded together in a “gas-tight” manner. In this case, the galvanic element or, in particular, the electrodes of the galvanic element, is or are isolated opposite the electrically conductive battery cell housing. For this purpose, for example, an insulating material can be arranged between an inner side of a wall of the battery cell housing and the galvanic element. For examining whether the insulation is free of defects, the insulation resistance between the battery cell housing and the galvanic element is determined and compared with the predetermined threshold value for insulation resistance by means of the sensor device, which, in the present case, is designed as a so-called insulation monitor. As soon as the measured insulation resistance goes below the threshold value, that is, as soon as the galvanic element is connected to the battery cell housing in a low-ohm manner, this indicates a defective insulation. Such a defective insulation can result in the circumstance that the current is guided via the electrically conductive battery cell housing. In the presence of defective insulation, the control device actuates the electronic switching element to block the current. The electronic switching element is thus operated in the blocking region. Now, in order to prevent the flow of current from being interrupted in a serial connection of battery cells, the control device additionally actuates the closing of the switching means and thus the bypassing of the specific battery cell with defective insulation. In spite of the defective battery cell, the battery thus advantageously remains functional.

According to an enhancement of the invention, the battery cell has a memory device for storing the physical and/or chemical property of the battery cell that is detected by the at least one sensor device, whereby the control device is designed for the purpose of closing the switching means so as to bypass the connection terminals, as a function of the physical and/or chemical property stored by the memory device. The signals of all sensors, for example, over time, can be saved in the memory device. Therefore, in particular, a change in the physical and/or chemical property of the battery cell over time, for example, from an initial state (BoL—beginning of life) up to a final state (EoL—end of life) of the battery cell, can be observed. A history of the battery cell service life can thus be created. Thus, for example, particular events, e.g., a particularly high acceleration to which the battery cell was subjected can be documented and retrieved at any time.

Possible memory devices that can be used are, for example, a so-called (ultra-) low energy memory or a FRAM (ferroelectric random access memory). Also, OTP (one time programmable) memory systems are offered for all programmable electronic components that can be secured against manipulation by an additional logic, e.g., by containing serial numbers or clear identification data or by entering these for the first time upon activation. The battery cell as well as all information on the battery cell can thus be particularly well protected against manipulation.

In one embodiment of the invention, the battery cell has a communication means for communicating with an overriding control device and/or with another battery cell. Such a communication means is preferably designed as a wireless transmission means that sends data, for example, via Bluetooth or WLAN. These data, which indicate, e.g., the state of charge of the particular battery cell, can be transmitted, for example, to a battery management system or to a control device of another battery cell of the same type. Thus, for example, when the serially connected battery cells have different states of charge, an equilibration of the states of charge, a so-called balancing, can be carried out. Such a balancing can be a so-called passives balancing, by which the most strongly charged battery cells can be discharged in a targeted manner via a switchable resistance, which is preferably arranged at the battery cell housing in such a way that the energy of the battery cell that is converted into heat by the resistance can be dissipated via the battery cell housing. Also, a balancing can be actively conducted, whereby the most weakly charged battery cells are charged in a targeted manner. This may be conducted, for example, by capacitive energy transmission via the battery cell housing of two battery cells or also by inductive energy transmission.

Thus, a state of the entire battery can be detected and monitored at any time in an advantageous way by the communication means, and therefore, the service life of the entire battery can be extended.

Preferably, the at least one sensor device is designed for the purpose of communicating the detected value of the physical and/or chemical property to the control device, only if the detected value in a first case exceeds a predetermined threshold value or in a second case if this value falls below another predetermined threshold value. Expressed in another way, this means that the detected value is communicated to the control device when the detected value is found outside a predetermined value region. The threshold value can be, for example, a maximum temperature value or a maximum pressure value inside the battery cell housing or a maximum current value between the connection terminals and the electrodes. Energy can be saved both on the transmitter side, i.e., on the side of the sensor devices, as well as on the receiver side, i.e., the side of the control device, due to this event-driven transmission of the data detected by the sensor device, since power is required for the transmission of the data only if the detected value changes. In the same way, the data can also be transmitted to the memory device in an event-driven manner. This energy-saving measure is particularly advantageous when the sensor devices, the control device, and the memory device are supplied with electrical energy by the galvanic element itself.

Another advantageous embodiment of the invention provides that the at least one sensor device and/or the control device and/or the memory device, for supplying energy, each have an energy conversion device that is designed for the purpose of converting energy from the environment into electrical energy. In this case, the energy conversion device is configured as a so-called energy harvesting sensor. Energy harvesting refers to the obtaining of small amounts of electrical energy from surrounding energy sources, such as ambient temperature, vibrations, air currents, light, and magnetic waves. The structures employed for this, i.e., the energy conversion devices, are also referred to as nanogenerators.

Such nanogenerators can be, for example, piezoelectric crystals that produce an electrical voltage by action of a force, for example, by pressure, vibration or sound, and/or thermoelectric generators, and pyroelectric crystals that obtain electrical energy from differences in temperature, and/or antennas, in particular passive RFIDs that collect and energetically use energy from radio waves or electromagnetic radiation, and/or sensors that convert light into electrical energy based on the photoelectric effect. In the case of wireless technologies, energy harvesting avoids limitations due to wired power supply or special or separate batteries.

In addition, the invention relates to a battery, particularly one having a serial connection of at least two battery cells according to the invention.

A motor vehicle according to the invention comprises at least one battery according to the invention. The motor vehicle can be configured, for example, as a passenger vehicle, in particular as an electric or hybrid vehicle. The motor vehicle can also be configured, however, as an electrically driven motorcycle or bicycle.

It is additionally possible, however, to provide the battery in a stationary energy storage system. In this way, it can be provided, for example, that a battery that had been used in a motor vehicle is re-used as a so-called second-life battery in the stationary energy storage system.

The preferred embodiments presented with respect to the battery cell according to the invention and the advantages thereof apply correspondingly to the battery according to the invention as well as to the motor vehicle according to the invention.

The invention will now be explained below in more detail on the basis of a preferred example of embodiment as well as with reference to the appended drawings.

The single FIGURE shows a schematic representation of an embodiment of a battery cell, which has a plurality of sensor devices and a bypass means.

The exemplary embodiment explained in the following involves a preferred embodiment of the invention. In the case of exemplary embodiments, however, the described components of each embodiment represent individual features of the invention that are to be considered independent from one another, each of the features also enhancing the invention independent from one another and thus are also to be viewed as a component of the invention, individually or in a combination that is different from that shown. In addition, the described embodiments can also be supplemented by other features of the invention that have already been described.

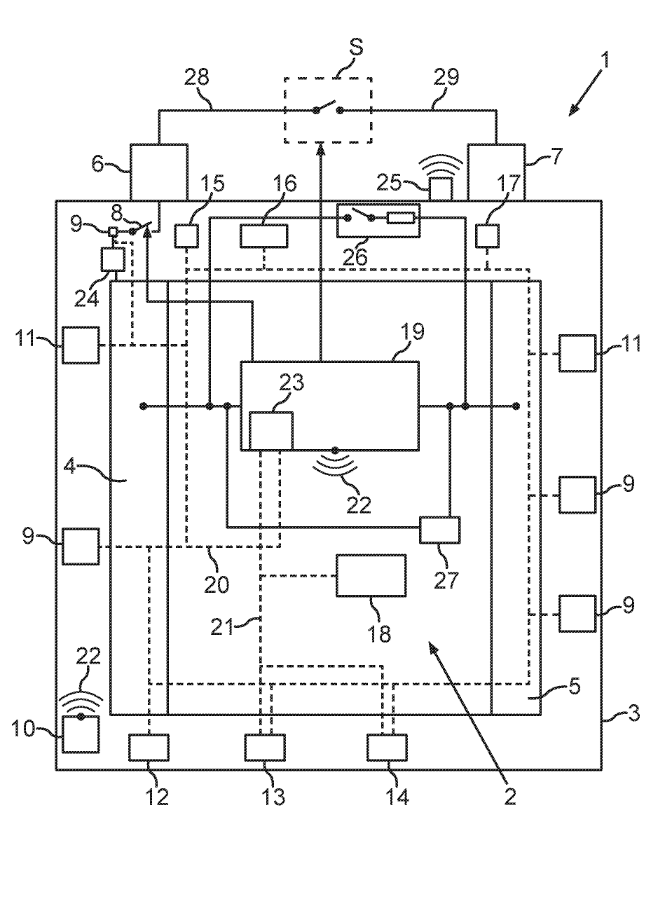

FIG. 1 shows a battery cell 1 having a galvanic element 2 or a battery cell coil as well as a battery cell housing 3. In this case, the galvanic element 2 is disposed in the battery cell housing 3. The battery cell housing 3 can be fabricated from aluminum, for example. The galvanic element 2 has a first electrode 4 and a second electrode 5. The battery cell housing 3 has two connection terminals 6, 7, wherein here, the first electrode 4 is connected to the first connection terminal 6 by way of an electronic switching element 8, and the second electrode 5 is directly connected to the second connection terminal 7. It can also be provided, however, that the second electrode 5 and the second connection terminal 7 are connected to each other via another electronic switching element. The electronic switching element 8 is particularly configured as a semiconductor switch, by means of which a flow of current can be controlled by applying a control voltage.

The energy provided from the galvanic element 2 via the connection terminals 6, 7 can be introduced to an electrical component for supplying energy to this component. Also, electrical energy can be introduced via the connection terminals 6, 7 to charge the battery cell 1. The battery cell 1 can also be connected together with other battery cells 1 of the same type, in particular serially, via the connection terminals 6, 7, to form a battery. Such a battery can be disposed, for example, in a motor vehicle, which is not shown here, to drive the motor vehicle. Such a battery, however, can also be provided in a stationary energy supply system, which is also not shown here.

Moreover, battery cell 1 has a switching means S, by means of which the connection terminals 6, 7 can be electrically connected to each other, and the battery cell 1 can be bypassed thereby. The switching means S may comprise, for example, a relay or a semiconductor switch. The switching means S, however, may also comprise a hybrid variant, which has a serial connection of relay and semiconductor switch.

In this case, the switching means S can be connected to the first connection terminal 6 via a first bus bar 28, and to the second connection terminal by way of a second bus bar 29. The switching means S can also be arranged inside the battery cell housing 3 and can be thermally coupled therewith, and thus can be cooled in an advantageous way via the battery cell housing 3.

In addition, the battery cell 1 here has a plurality of sensor devices 9, 10, 11, 12, 13, 14, 15, 16, 17, 18 for detecting physical and/or chemical properties of the battery cell 1, and a control device 19.

The sensor devices 9, 10, 11, 12, 13, 14, 15, 16, 17, 18 are designed for the purpose of communicating with the control device 19 via signal paths 20, 21, 22. Here, the sensor devices 9, 11, 12, 13, 14, 15, 16, 17, together with the control device 19, form network nodes of a network that has a bus topology here as the network topology. In this case, the signal path 20 can be designed as a line, for example, an electrical line or an optical line. Also, however, it may be that the sensor devices 9, 11, 12, 13, 14, 15, 16, 17 communicate wirelessly with the control device 19, via WLAN, RFID, Bluetooth or light pulses. In this case, each of the sensor devices 9, 11, 12, 13, 14, 15, 16, 17 can communicate with the control device 19 either directly or via another of the sensor devices 9, 11, 12, 13, 14, 15, 16, 17. In other words, this means that each of the sensor devices 9, 11, 12, 13, 14, 15, 16, 17 can further convey the signal to another of the sensor devices 9, 11, 12, 13, 14, 15, 16, 17. Other network topologies are also possible, for example, a full mesh net, a mesh net, a tree topology, a line topology, or a star topology. With such a configuration of the battery cell 1, redundant signal transmission paths can be formed.

The sensor device 10 communicates directly here with the control device 19 via a wireless connection 22, for example, WLAN or Bluetooth.

The sensor devices 13, 14, 18 communicate here with the control device 19 via a bus system 21, for example, a LIN, CAN, I²C, SPI, UART. The control device 19 has corresponding interfaces for this purpose.

The sensor devices 9, 10 are designed, for example, as temperature sensors that detect a temperature inside the battery cell housing 3. The sensor devices 11, are designed, for example, as sensors for measurement of an insulation resistance between the galvanic element 2 and the battery cell housing 3. The insulation measurement can establish whether a low-ohm, electrically conducting connection exists between the battery cell housing 3 and the galvanic element 2 or whether a high-ohm, insulating connection exists between the battery cell housing 3 and the galvanic element 2. The sensor device 12 is configured here as a density sensor for measuring the density of the electrolyte of the galvanic element 2; the sensor device 13 is configured as a conductivity sensor for measuring the conductivity of the electrolyte; and the sensor device 14 is configured as a spectral analysis sensor for measuring the chemical composition of the electrolyte. The sensor device 15 is designed as a pressure sensor for measuring the pressure inside the battery cell housing 3. The sensor device 16 is designed here as a gas sensor, by means of which, for example, a decomposition of the electrolyte can be determined. The sensor device 17 here is an acceleration sensor for measuring the acceleration to which the battery cell 1 is subjected. The sensor device 18 is configured as a force sensor, by means of which a deformation of the battery cell 1 can be measured.

The data of all of these sensor devices 9, 10, 11, 12, 13, 14, 15, 16, 17, 18 are supplied to the control device 19, which is connected here to the electrodes 4, 5 of the galvanic element 2. Therefore, a stable current and voltage supply of the control device 19 can be ensured. The control device 19 in this case may additionally have an EMV (electromagnetic compatibility) filter as well as a voltage measuring unit. In addition, the control device 19 may have a so-called security unit for more secure transmission and storage of data. In this case, the security unit is designed, for example, for the encryption and decryption of the data.

The control device 19 is presently designed for the purpose of determining battery-specific characteristic values of battery cell 1, for example, a degree of damage or a state of charge of the battery cell 1, based on the sensor data. Furthermore, an impedance analysis or impedance microscopy can be carried out by the control device 19 inside the battery cell 1, in order to determine the complex internal resistance as a function of the frequency and/or the temperature. The sensor data can also be saved in a memory device 23, in order to monitor, for example, the battery cell 1 over its entire service life. By way of example, the state of charge, the SoH (state of health), current profiles, current peaks, trends or gradients of all data from the sensor devices 9, 10, 11, 12, 13, 14, 15, 16, 17, 18, temperature profiles, characteristic curve fields and protected source codes can be stored in the memory device. By means of the data that can be read out from memory 23, for example, without further tests, an analysis can be made of whether the battery is suitable for reuse, a so-called second life, for example, in a stationary energy storage system. The data can be compressed, for example, by an input algorithm on the control device 19, in order to enter the data into the memory device 23. The data can be entered continuously, at defined time points, or can be event-driven.

Based on the battery-specific characteristic values, the control device 19 is designed for the purpose of actuating the closing of the switching element S and thus for bypassing the battery cell 1. If, for example, an insulation defect has been established by the sensor device 11, then this is transmitted to the control device 19, which actuates the closing of the switching means S.

Moreover, the control device 19 is designed for the purpose of dynamically adapting, for example limiting or reducing, the current between the first connection terminal 7* and the first electrode 4 as a function of the detected physical and/or chemical properties, for example, as a function of the battery cell 1 over its service life. In the case of an insulation defect, it is particularly advantageous, if the control device 19 additionally actuates the electronic switching element 8 for blocking a flow of current between the electrode 4 and the connection terminal 6.

In order to monitor the flow of current between the first electrode 4 and the first connection terminal 6, a highly precise current sensor 24 is disposed here between the electrode 4 and the connection terminal 6.

Conversely, the control device 19 can also send signals to the sensor devices 9, 10, 11, 12, 13, 14, 15, 16, 17, 18 for operating the sensor devices 9, 10, 11, 12, 13, 14, 15, 16, 17, 18.

In addition, the battery cell 1 has here a communications device 25 that is designed for the purpose of communicating with an overriding battery management system, which is not shown here, and/or another battery cell 1 of the same type. The battery-specific characteristic values, for example, the state of charge of the battery cell 1, can be transmitted by means of the communications device 25 to the overriding battery management system, which compares the transmitted state of charge to the states of charge of the other battery cells of the battery. If the battery cell 1, for example, has a state of charge that is higher in comparison to other battery cells, then a so-called passive balancing can be conducted by means of a switchable resistance 26. For this purpose, the electrical energy is withdrawn from the galvanic element 2 in a targeted manner, and is converted to heat energy via the switchable resistance 26. The battery cell 1 is thus discharged. In this case, it is particularly advantageous if the switchable resistance 26 is thermally coupled to the battery cell housing 3, so that the electrical energy converted to heat can be discharged to the surroundings by way of the battery cell housing 3.

It can also be provided that the battery cell 1 is discharged by means of a so-called active balancing, and the discharge energy is conveyed via the energy transmission means 27 to charge another battery that has a lower charge. Conversely, the battery cell 1 can be charged via the energy transmission means 27. The energy transmission means 27 can transmit energy, for example, capacitively or inductively.

In this case, intelligent charging strategies can be given in advance for the battery cell 1 by the control device 19, in order to prolong the service life of the battery cell 1 by optimal charging and discharging. For this purpose, a charging station, i.e., a device for providing charging energy, for example, from the control device 19, can be actively informed by way of the communications device 25 on the actual state of the battery cell 1. Therefore, charging can be actively disconnected in the case of critical states of the battery cell 1.

Also, each of the sensor devices 9, 10, 11, 12, 13, 14, 15, 16, 17, 18 and/or the control device 19 and/or the memory device 23 can have an energy conversion means, which is not shown here, which is configured as a so-called energy harvesting sensor. The obtaining of small quantities of electrical energy from sources such as ambient temperature, vibrations or air flows is designated as energy harvesting. The structures employed for this, i.e., the energy conversion devices, are also referred to as nanogenerators. In the case of wireless technologies, energy harvesting avoids limitations due to a wired power supply or special or separate batteries.

Such nanogenerators can be, for example, piezoelectric crystals that produce an electrical voltage by action of a force, for example, by pressure, vibration or sound, and/or thermoelectric generators, and pyroelectric crystals that obtain electrical energy from differences in temperature, and/or antennas, in particular passive RFIDs that collect and energetically use energy from radio waves or electromagnetic radiation, and/or sensors that convert light into electrical energy, based on the photoelectric effect.

Also, all electronic components of the battery cell 1, thus the sensor devices 9, 10, 11, 12, 13, 14, 15, 16, 17, 18, and/or the control device 19, and/or the memory device 23, can be realized as so-called “low power” designs, in particular, as “ultra-low power” designs. This means that these electronic components have a particularly low energy consumption.

Therefore, the electronic components can be operated in a sleep mode (“deep sleep”), in which the electronic components are completely deactivated, in order to save on current. An activation can occur, for example, by way of a command or a so-called interrupt. In this case, an activation can occur as a rapid start (“fast start”), i.e., as an extremely rapid “booting up” or continuation of the function sequence, for example, inside the control device 19. Advantageously, for this purpose, an initializing routine is not necessary, since the normal cyclic operation is again simply continued. An activation may also occur as a waking up (“wake up”), in which all functions are reactivated, for example, in an event-driven manner.

Therefore, energy is then consumed, for data transfer, for example, only when a change, in particular a significant change, in a physical and/or chemical property has been detected, for example, by one of the sensor devices 9, 10, 11, 12, 13, 14, 15, 16, 17, 18. For example, such a change is the exceeding of a predetermined threshold value or going below another predetermined threshold value or the presence of new minimum or maximum values for a physical and/or chemical property of the battery cell 1.

In particular, the control device 19 is designed for the purpose of making possible a safe operation simultaneously with extremely low current consumption. For this purpose, the current consumption can be lowered via a reduction in clock rate and operating voltage. Also, additional special register functions SRF or special software commands may be provided.

Due to the energy saving measures, for example, by intelligent programming of the electronic components, the battery cell 1 can be prevented from discharging when the electronic components are supplied with electrical energy by the galvanic element 2 itself.

The calculation and analysis of the data can also be carried out outside the battery cell 1 by transmitting the data to a powerful computing unit, for example, by means of the communications device 25. The analyzed and calculated data, i.e., the results, can subsequently be transmitted to the control device 19 of the battery cell 1, which actuates, for example, the closing of the switching means S and/or the electronic switching element 8 to limit the current.

1-10. (canceled)

11. A battery cell for a battery of a motor vehicle, comprising
a galvanic element with a first electrode and a second electrode, a battery cell housing with a first connection terminal and a second connection terminal, at least one sensor device for detecting a physical and chemical property of the battery cell, and a control device, wherein the galvanic element is disposed in the battery cell housing, wherein the battery cell has a switching means, by means of which the first connection terminal and the second connection terminal can be electrically connected, and the control device is designed for the purpose of closing the switching means in order to bridge over or bypass the battery cell as a function of the physical and/or chemical property detected by the at least one sensor device.

12. The battery cell according to claim 11, wherein the switching means is disposed in the battery cell housing and is thermally coupled to the battery cell housing.

13. The battery cell according to claim 11, wherein at least one of the electrodes is connected to one of the connection terminals by an electronic switching element, wherein the electronic switching element is designed for the purpose of limiting a current flow between the electrode and the particular connection terminal, and the control device is designed for the purpose of actuating the electronic switching element for limiting the current flow as a function of the physical and chemical property detected by the at least one sensor device.

14. The battery cell according to of claim 11, wherein the at least one sensor device is designed for the purpose of detecting an insulation resistance between the galvanic element and the battery cell housing, and the control device is designed for the purpose of closing the switching means for bypassing the connection terminals and to actuate the electronic switching element to limit the current, if the insulation resistance falls below a predetermined threshold value for the insulation resistance.

15. The battery cell according to claim 11, wherein the battery cell has a memory device for storing the physical and chemical property of the battery cell detected by the at least one sensor device, wherein the control device is designed for the purpose of closing the switching means so as to bypass the connection terminals, as a function of the physical and chemical property stored by the memory device.

16. The battery cell according to claim 11, wherein the battery cell has a communication means for communicating with an overriding control device and with another battery cell.

17. The battery cell according to claim 11, wherein the at least one sensor device is designed for the purpose of transmitting the detected value of the physical and chemical property to the control device only if the detected value in a first case exceeds a predetermined threshold value, or in a second case if this value falls below another predetermined threshold value.

18. The battery cell according to claim 11, wherein the at least one sensor device and the control device and the memory device have an energy conversion device for supplying energy, which is designed for the purpose of converting energy from the surroundings into electrical energy.
